(19) United States
(12) Patent Application Publication
(10) Pub. No.: US 2004/0073527 A1
(43) Pub. Date: Apr. 15, 2004

(54) Method, system and computer software for predicting protein interactions

(76) Inventor: Alan B. Sherr, Mountain View, CA (US)

Correspondence Address: Alan B. Sherr, 800 High School Way #326, Mountain View, CA, 94041, US

(21) Appl. No.: 10/453,389

(22) Filed: Jun. 3, 2003

Related U.S. Application Data
(60) Provisional application No. 60/385,626, filed on Jun. 4, 2002.

(51) Int. Cl. G06E 3/00

(52) U.S. Cl. 706/20

(57) ABSTRACT

Computer systems, methods, and products use adaptive systems, such as neural networks, to classify protein domains according to their hydropathic, steric, electrostatic, and other properties, and to predict the characteristics of domains with which they will bind based on these properties. Optionally, the systems, methods, and products also predict protein function based on the physical/chemical properties of one or more domains of the protein.

### RELATED APPLICATION

The present application claims priority from U.S. Provisional Patent Application Serial No. 60/385,626, entitled “METHOD, SYSTEM AND COMPUTER SOFTWARE FOR PREDICTING PROTEIN INTERACTIONS”, filed Jun. 4, 2002, which is hereby incorporated herein by reference in its entirety for all purposes.

### FIELD OF THE INVENTION

The present invention relates to the field of bioinformatics. In particular, the present invention relates to computer systems, methods, and products for predicting protein-protein interactions.

### BACKGROUND

Research in molecular biology, biochemistry, and many related health fields increasingly requires organization and analysis of complex data generated by new experimental techniques. These tasks are addressed by the rapidly evolving field of bioinformatics. See, e.g., H. Rashidi and K. Buehler, Bioinformatics Basics: Applications in Biological Science and Medicine (CRC Press, London, 2000); Bioinformatics: A Practical Guide to the Analysis of Gene and Proteins (B. F. Ouelette and A. D. Bzevanis, eds., Wiley & Sons, Inc.; 2d ed., 2001), both of which are hereby incorporated herein by reference in their entireties. Broadly, one area of bioinformatics applies computational techniques to large genomic databases, often distributed over and accessed through networks such as the Internet, for the purpose of illuminating relationships among gene structure and/or location, protein function, and metabolic processes.

### SUMMARY OF THE INVENTION

At the present stage of proteomic development, accurate prediction of protein-protein interactions by computational techniques is a crucial adjunct to experimental measurement of protein-protein interactions and development of protein expression profiles (e.g., by yeast two hybrid, mass spectrometry, GIST, ICAT, and other methods).

See, e.g., Proteomics: from protein sequence to function (S. Pennington & M. Dunn, eds.) (BIOS Scientific Publishers, Ltd., 2001); A. Tong, et al., A Combined Experimental and Computational Strategy to Define Protein Interaction Networks for Peptide Recognition Modules, “295 Science 321-324 (January 2002); A. Enright, et al., “Protein interaction maps for complete genomes based on gene fusion events,” 402 Nature 86-90 (November 1999); J. Rain, et al., “The protein-protein interaction map of Helicobacter pylori,” 409 Nature 211-215 (January 2001); Y. Ho, et al., “Systematic identification of protein complexes in Saccharomyces cerevisiae by mass spectrometry,” 415 Nature 180-183 (January 2002); G. Ball, et al., “An integrated approach utilizing artificial neural networks and SELDI mass spectrometry for the classification of human tumours and rapid identification of potential biomarkers,” 18:3 Biomnformatics 395-404 (Oxford Univ. Press 2002); A. Sali, “Functional links between proteins,” 402 Nature 23-26 (November 1999); F. Regnier, et al., Comparative proteomics based on stable isotope labeling and affinity selection,” J. Mass Spectrom. 2002; 37: 133-145. More specifically, improved computational prediction of protein-protein interactions elucidates crucial biological activities including the formation of stable (e.g., ribosome) or temporary (e.g., spliceosome) protein complexes, and numerous protein-mediated pathways (e.g., signal transduction, metabolic). The prediction of protein-protein interactions is thus an enabling technology applicable to academic and commercial efforts to identify interdiction strategies for preventing or treating genetic or other diseases and medical conditions. For example, drug companies devote enormous resources to identification of small molecules capable of selectively binding to targeted proteins in order to interrupt disease-related pathways or complex formation. The principal tools in this effort, including so-called “rational” drug design and combinatorial methods of drug identification, depend on accurate information regarding the appropriate target proteins. Rational drug design also depends on accurate information regarding the properties of the binding domains of the target proteins.

Computer systems, methods, and products are described herein with respect to illustrative implementations of the present invention that use neural networks to classify protein domains according to their hydropathic, steric, electrostatic, and other properties, and to predict the characteristics of domains with which they will bind based on these properties. Optionally, the systems, methods, and products also predict protein function based on the physical/chemical properties of one or more domains of the protein.

More specifically, in one embodiment a system is described that includes a domain property specifier constructed and arranged to specify one or more properties of each of a plurality of training domains and to specify one or more properties of a query domain of a query protein. Also included is an encoder constructed and arranged to encode the properties of the training domains and the properties of the query domain. Another element is an adaptive learner constructed and arranged to (a) receive the encoded properties of the training and query domains, (b) adapt one or more parameters based on the encoded properties of the training domains, and (c) respond to the encoded properties of the query domain based, at least in part, on the adapted parameters. In some implementations, the adaptive learner may include an artificial neural network. Also, in some implementations, the one or more properties of the training domains and the one or more properties of the query domain may include any one or more of steric, hydropathic, or electrostatic properties. The query protein may be determined based, at least in part, on a result of an experiment including a microarray. The query protein may be determined based on a query gene, which may be determined based, at least in part, on a result of an experiment including a microarray. For example, the microarray may be a synthesized array of oligonucleotides comprising probes associated with genes or EST's.

In accordance with another embodiment, a method is described that includes specifying one or more properties of each of a plurality of training domains; specifying one or more properties of a query domain of a query protein; encoding the properties of the training domains and the properties of the query domain; adapting one or more parameters based on the encoded properties of the training domains; and responding to the encoded properties of the query domain based, at least in part, on the adapted parameters. In some implementations, the one or more properties of the training domains and the one or more properties of the query domain may include any one or more of steric, hydropathic, or electrostatic properties.

In accordance with yet another embodiment, a system is described that includes a computer comprising a processor and a memory unit having stored therein a domain-interaction-prediction executable (i.e., an executable form of a software application). When executed by the processor, the application performs a method including specifying one or more properties of each of a plurality of training domains; specifying one or more properties of a query domain of a query protein; encoding the properties of the training domains and the properties of the query domain; adapting one or more parameters based on the encoded properties of the training domains; and responding to the encoded properties of the query domain based, at least in part, on the adapted parameters. A computer program product is described in accordance with a further embodiment that, when executed on a computer, performs a method including specifying one or more properties of each of a plurality of training domains; specifying one or more properties of a query domain of a query protein; encoding the properties of the training domains and the properties of the query domain; adapting one or more parameters based on the encoded properties of the training domains; and responding to the encoded properties of the query domain based, at least in part, on the adapted parameters.

A method is also described in accordance with another embodiment that includes specifying one or more properties of each of a plurality of training domains; specifying one or more functions of proteins corresponding to the plurality of training domains; specifying one or more properties of a query domain of a query protein; encoding the properties of the training domains and the properties of the query domain; adapting one or more parameters based on the encoded properties of the training domains and the functions; and responding to the encoded properties of the query domain based, at least in part, on the adapted parameters. In accordance with yet another embodiment, a computer program product is described that, when executed on a computer, performs a method including specifying one or more properties of each of a plurality of training domains; specifying one or more functions of proteins corresponding to the plurality of training domains; specifying one or more properties of a query domain of a query protein; encoding the properties of the training domains and the properties of the query domain; adapting one or more parameters based on the encoded properties of the training domains and the functions; and responding to the encoded properties of the query domain based, at least in part, on the adapted parameters.

Yet another embodiment is described of a system that includes means for specifying one or more properties of each of a plurality of training domains and specifying one or more properties of a query domain of a query protein; means for encoding the properties of the training domains and the properties of the query domain; and means for adapting one or more parameters based on the encoded properties of the training domains and responding to the encoded properties of the query domain based, at least in part, on the adapted parameters.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments or implementations. Also, any one or more function, step, operation, or technique described elsewhere in this specification may, in alternative implementations, be combined with any one or more function, step, operation, or technique described in the summary. Thus, the above embodiments and implementations are illustrative rather than limiting.

### BRIEF DESCRIPTION OF THE DRAWINGS

In the drawings, like reference numerals indicate like structures or method steps and the leftmost digit of a reference numeral indicates the number of the figure in which the referenced element first appears (for example, the element 305 appears first in FIG. 3). In functional block diagrams, rectangles generally indicate functional elements and parallelograms generally indicate data. These conventions, however, are intended to be typical or illustrative, rather than limiting.

FIG. 1 is a functional block diagram of one embodiment of a user computer suitable for executing a computer program product in accordance with the present invention and for obtaining information over the Internet for use by the computer program product;

FIG. 2 is a functional block diagram of the functional elements of an illustrative computer program product in accordance with the present invention;

FIG. 3 is a functional block diagram of one embodiment of a neural network application that is a component of the computer program product of FIG. 2; and

FIG. 4 is a graphical representation of training data and/or query data that may be processed by the computer program product of FIG. 2 and showing an example of clustering or associating of the data by the neural network application of FIG. 3.

### DETAILED DESCRIPTION

Systems, methods, and computer products are now described with reference to an illustrative embodiment referred to as Domain Interaction Predictor (DIP) application 199. DIP is a software application for execution on a user computer (e.g., PC or workstation) with access to the Internet. These systems, methods, and products may be used in conjunction with the system, methods, and products described in U.S. patent application, Ser. No. 10/063,559 filed May 2, 2002, entitled “Method, System and Computer Software for Providing a Genomic Web Portal,” which is hereby incorporated herein by reference in its entirety for all purposes.

Advantageously, DIP application 199 in the illustrated implementation makes predictions of protein-protein interactions based, at least in part, on fundamental properties of the three-dimensional protein domains involved in binding. In contrast, conventional bioinformatic-based predictions of protein-protein interactions often assess the similarity of a query protein to other proteins having known protein interactions using sequence comparisons and/or structure comparisons. See Cornell University, Computational Biology Tools, http://www.tc.cornell.edu/reports/NIH/resource/CompBiologyTools/; see also J. Wojcik & V. Schachter, “Protein-protein interaction map inference using interacting domain profile pairs,” 17 Suppl. 1 Bioinformatics S296-S305 (Oxford University Press 2001). The sequence-based approaches, while very useful in providing a rapid list of proteins that may have binding domains similar to that of the query protein, are known to be subject to error because (a) proteins of similar sequences may have significantly different properties, including three-dimensional structure and other binding properties, and (b) proteins of non-similar sequences may have similar properties, including similar three-dimensional structure. Moreover, conventional approaches based on similarity of three-dimensional structure are also insufficient for accurately predicting protein interactions because structure alone does not determine binding affinity. In particular, the electrostatic and hydropathic properties of the interacting domains, among various aspects, should be considered.

In accordance with one conventional approach, a software application called FTDock (for Fourier Transform Dock) applies steric and electrostatic properties to predict protein-protein docking. FTDock was developed by the Imperial Cancer Research Fund's Biomolecular Modelling Laboratory and is made available by researchers at the University of Nottingham Greenfield Medical Library, Nottingham England. The software “performs rigid-body docking on two biomolecules in order to predict their correct binding geometry based on surface shape complementarity and electrostatic interactions.” A companion application then “reranks candidate docking orientations . . . using an empirical scoring function derived from a library of protein-protein interfaces.” Imperial Cancer Research Fund's Biomolecular Modelling Laboratory, The 3D-Dock Suite, http:/bioresearch.ac.uk/browse/mesh/detail/C0033618L0005455.html. The approach taken by FTDock is thus very different from that taken by DIP. Whereas FTDock starts with two molecules and predicts their docking potential, DIP of the illustrated implementation starts with a single query molecule and predicts the properties of a hypothetical molecule (i.e., the binding domain portion of a protein). DIP then specifies one or more candidate interacting proteins having binding domains similar to that of the hypothetical molecule. It is believed that this approach is novel and also provides the significant advantage (with respect to FTDock) that a potential binding partner need not be known. Rather, DIP predicts the binding partner of a query protein. Thus, unexpected protein interactions may be identified.

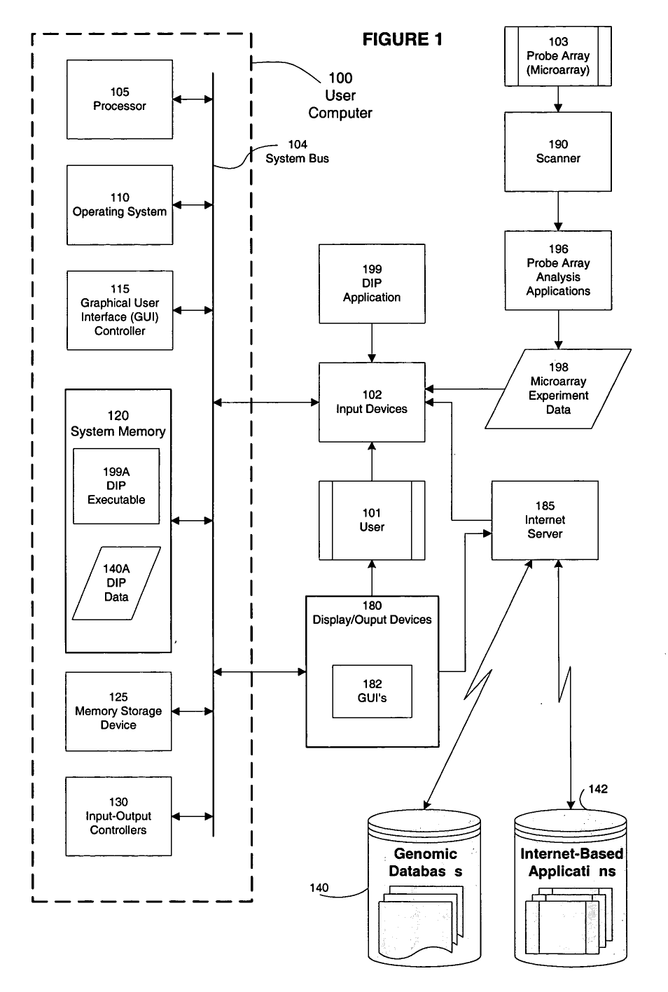

FIG. 1 shows a typical computer configuration suitable for running DIP that includes a user computer 100 having various conventional components such as central processor 105, operating system 110, and system memory 120. In the conventional manner, DIP software application 199 is loaded into system memory where its functions are carried out by DIP executable 199A. In the course of execution as described below, executable 199A stores, manipulates, and retrieves DIP data 140A in system memory. DIP executables 199A receives input from, and provides information to, a user 101 via input/output devices and user interfaces.

Generally speaking, DIP carries out its operations in three modes: (a) data acquisition, (b) neural network encoding and training, and (c) neural network querying. In the data acquisition mode, DIP uses conventional techniques to access Internet-based applications 142 (e.g., applets downloaded to computer 100 or processes running on network application servers) and genomic databases 140. To provide faster execution and greater reliability, other implementations of DIP may be configured to optionally store Internet-based applications and/or databases in local memory (e.g., system memory and/or memory units distributed over a local network or intranet). These local databases would periodically be updated over the Internet.

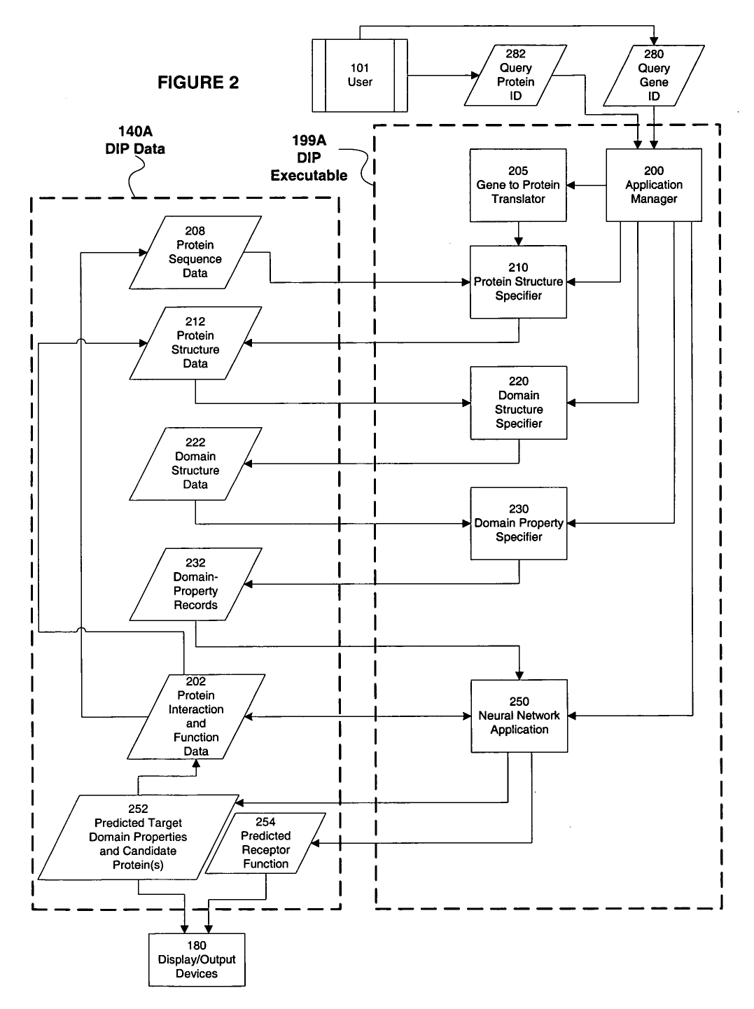

FIG. 2 is a functional block diagram showing various data structures included in DIP data 140A and their interactions with various processes shown as functional elements of DIP executables 199A. The objective of the data acquisition mode is to populate domain-property index records 232 with information regarding the hydropathic, steric, electrostatic, and other properties (collectively referred to hereafter simply as “properties”) of binding domains of protein-protein pairs. To achieve this objective, DIP protein structure specifier 210 retrieves protein sequence data 208 from genomic databases over the Internet. The sequences are of proteins identified as interacting with other proteins. Protein interaction data is available over the Internet from numerous sources, e.g., Regents of the University of California, Database of Interacting Proteins, http://dip.doe-mbi.ucla.edu/; Samuel Lunenfeld Research Institute, Biomolecular Interaction Network Database, http://Hwww.bind.ca/index.phtml. This protein interaction data, and information regarding the functions of the proteins (see, e.g., National Center for Biotechnology Information (NCBI), Entrez Protein,

http://www.ncbi.nlm.nih.gov/entrez/query.fcgi?db=Protein) are also retrieved over the Internet from genomic databases, and the retrieved data are stored in protein interaction and function data structure 202. (See, for example, P. Legrain, “Protein domain networking,” 20 Nature Biotechnology 128-129 (Feb. 2002). Various conventional techniques are used to acquire, parse, and store this data, such as may be implemented using Perl, BioPerl, or other programming languages. See L. Stein, “Using Perl to Facilitate Biological Analysis,” in A. Baxevanis and B. Ouellette, Bioinformatics: A Practical Guide to the Analysis of Genes and Proteins (Wiley-Liss, 2001). Protein structure specifier 210 converts the protein sequence data to structure data according to known techniques (see, for example, Imperial College of Science, Technology, and Medicine, 3D-PSSM Threading Server, http://www.sbg.bio.ic.ac.uk/˜3dpssm/) or those that may be developed in the future, and stores the results in protein structure data structure 212. Also, protein structure specifier 210 obtains protein structure data directly from Internet-based protein structure databases (for example, from Protein Data Bank (PDB) Documentation and Information,

http://www.rcsb.org/pdb/File Formats and Standards; Genome Web Protein 3D Structure Analysis, http://www.hgmp.mrc.ac.uk/GenomeWeb/prot-3-struct.html; Laboratoire de Conformation des Proteines of the Institute of Biology and Chemistry of Proteins, Centre National de la Recherche Scientifique, Universite Claude Bernard, Lyon, ANTHEPROT (ANalyse THE PROTeins) Software Application,

http://bioresearch.ac.uk/browse/mesh/detail/C0162807L0190092.html, and stores the results in data structure 212.

Domain structure specifier 220 employs a variety of known programs and techniques, or ones that may be developed in the future, for (a) identifying protein sequences associated with protein domains (e.g., EMBL-European Bioinformatics Institute, 3 Dee—Database of Protein Domain Definitions,

http://jura.ebi.ac.uk:8080/3Dee/help/help_intro.html), and (b) identifying the secondary and tertiary structures associated with those domains (e.g., Analytical Biostatistics Section, Mathematical and Statistical Computing Laboratory, Center for Information Technology, National Institutes of Health, Protein Structure Prediction,

http://abs.cit.nih.gov/index.html), in order to populate domain structure data structure 222. Domain property specifier 230 operates on the domain structure data to specify domain properties (stored in domain-property records 232) using, for example, techniques applied by bioinformaticists involved in drug development and other chemical applications. These techniques have been developed and applied with respect to three dimensional chemical structures and generally are not based on the sequences of molecules (as compared, for example, to sequence-based estimations of hydropathic properties of proteins; see, e.g., Weizmann Institute of Science Genome and Bioinformatics, Protein Hydrophilicity/Hydrophobicity Search and Comparison Server,

http://bioinformatics.weizmann.ac.il/hydroph/hydroph_help.html). In particular, a field of inquiry into “quantitative structure activity/property relationships (QSAR or QSPR; see, e.g., The Australian Computational Chemistry via the Internet Project, “QASR,”

http://www.chem. swin.edu.au/modules/mod4/index .html) has evolved to quantify hydropathic (e.g., eduSoft, HINT! Molecular Modeling System v. 2.35,

http://www.edusoft-lc.com/hint/), steric (e.g., B. Taverner, Steric (software application),

http://hobbes.gh.wits.ac.za/craig/steric/), electrostatic (e.g., Accelrys, “C².FieldFit,”

http://www.accelrys.com/cerius2/c2fieldfit.html), and other (e.g., “The Visual Quantum Mechanics Project funded by the National Science Foundation,” http://phys.educ.ksu.edu/) properties of compounds based on analysis of the three-dimensional structure of compounds. (The three named properties are selected because they are most directly related to binding affinities between compounds whereas others, such as quantum chemical properties, are descriptive at a finer level.) For example, the HINT!® program available from eduSoft translates the thermodynamic parameter LogP, as well as hydrophobicity measures, into three-dimensional representations of bio-molecular systems. As another example, a software application called “QSAR with CoMFA®” employs QSAR to relate a molecule's structure to its chemical properties or biological activity (see Tripos, Inc., QSAR with CoMFA, http://www.tripos.com/software/gsar.html).

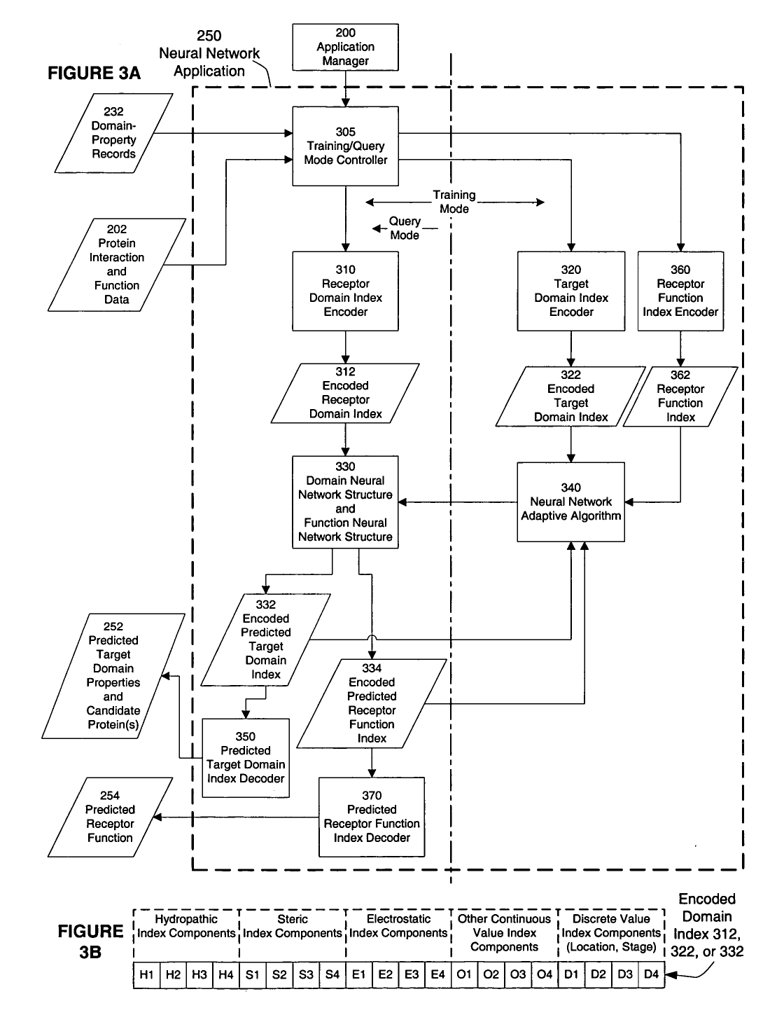

In the training mode, DIP uses the domain properties stored in records 232 to adaptively vary interconnection weights among nodes, or adapt other elements (e.g., thresholds, connections among nodes, pruning or connection enhancement parameters, and so on), in a neural network as illustratively shown in FIG. 3A and FIG. 3B. Mode controller 305 accesses protein-protein interaction data stored in data structure 202. Controller 305 also identifies from records 232 the domain property records (where each record is, for example, a collection of data representing hydropathic, steric, and electrostatic properties of a domain) corresponding to the binding domains of each of the protein pairs identified from data structure 202. It will be understood that the word “record” is used for illustrative purposes and that the data may be stored or processed in accordance with numerous techniques and formats known to those of ordinary skill in computer arts. With respect to the present illustration, in a first iteration controller 305 identifies an index record specifying the properties of a domain A of one protein and identifies another index record specifying the properties of domain B of a second protein, where domains A and B are identified (e.g., via data structure 202) as being mutually interacting binding domains. Controller 305 designates one of the interacting domain pairs as the “receptor” domain and the other as the “target” domain. In the present implementation, controller 305 then provides the properties of the receptor domain to receptor domain index encoder 310 and the properties of the target domain to target domain index encoder 320. Encoders 310 and 320 encode these domain properties in accordance with conventional techniques for encoding information for processing by neural networks. See, for example, C. Wu and J. McLarty, Neural Networks and Genome Informatics (Elsevier, 2000).

FIG. 3B is a graphical representation of the encoded domain properties in a form appropriate for representing index 312, as well as indexes 322 and 332 described below. Thus, in this example, a first component of the domain's hydropathic properties (e.g., the domain's LogP value) is shown as a first hydropathic index component Hi. Components H2 through H4 could, as further examples, represent the octanol/water partition coefficient, parachor index, or water solubility value associated with the domain in the domain's record in data structure 232. Similarly, components S1 through S4 could represent steric properties of the domain as indicated by molecular volume, shape, surface area, or refractivity; and components E1 through E4 could represent the domain's electrostatic properties as indicated by its Hammett constant, Taft polar substituent constant, ionization potential, dielectric constant, or dipole moment. Domain properties other than these may also be included, as indicated by the category “other continuous value index components” O1 through O4. In contrast to all of the preceding properties that typically take on continuous values, domains may also have properties that can be described as being confined to discrete values. For example, a protein may be expressed, or interact with other proteins, only in a particular cellular location or a particular organ. As another example, a protein may only be expressed during a particular stage of development of an organism or during a particular cell cycle. Thus, a protein domain that is present only in one location or at one stage cannot interact with a protein domain that is present only in another location or at another stage. These hard and discrete limitations are incorporated into the operation of neural networks 330 and algorithm 340 by any of a variety of techniques such as by associating them with appropriate weights or firing thresholds, or by otherwise biasing or determining the neural network operations to conform to the limitations.

In the illustrated implementation, each of the index components shown in FIG. 3B (except the discrete value indexes in some designs) serves as a node in input layers of two neural network structures: one neural network structure for predicting target domain indexes (referred to as the domain neural network structure), and another neural network structure for predicting protein function (referred to as the protein neural network structure). Both structures are represented in FIG. 3A by element 330. Network structures 330 each include a hidden layer of nodes that receives weighted input from the input nodes and provides weighted output to an output layer of nodes. Additional hidden layers may be provided, and additional neural networks may be cascaded or otherwise connected. More generally, a variety of neural network designs may be employed (see, e.g., C. Wu and J. McLarty, supra, at 33-50). A useful feature of the neural network design with one or more hidden layers is that it provides rapid, non-linear, partitioning, categorization, or association of output data in N dimensions, where N is the number of output nodes.

The weights connecting the input-layer nodes to the hidden-layer nodes, and the weights connecting the hidden-layer nodes to the output nodes, as well as other parameters associated with neural network structures, are initialized for both of structures 330. The encoded receptor domain index for domain A of the present example is provided to the input nodes of structures 330. The domain neural network structure provides values at its output nodes (encoded predicted target domain index 332) intended to represent the properties of a hypothetical domain that is predicted to bind with domain A. Assuming as in this illustrative example that no training has yet taken place, however, the values in index 332 are initially a reflection of the initial assigned weights but not representative of predicted properties. The encoded target domain index 322, representing the encoded properties of domain B in this example, do represent the properties of a domain that binds with domain A. Indexes 332 and 322 are provided to neural network adaptive algorithm 340 that, based on a measure of difference between indexes 332 and 322 (which may be any of a variety of measuring differences, such as Euclidean distance or Pearson linear correlation), adjusts the weights connecting nodes of the domain neural network structure. This process may then be repeated except that domain B is treated by controller 305 as the receptor domain and domain A is treated as the target domain. A second pair of records of interacting domains is then selected from domain-property records 232 and another pair of training iterations is conducted. The neural network is designed so that there is a tendency over many iterations, including substantial numbers of iterations for each of a number of domain pairs with similar properties (referred to as a “domain family”), to reduce the difference between predicted index 332 and target index 322. When the difference reaches an optimal training level (as determined by various measures designed to avoid over-training), the domain neural network structure is deemed to be fully trained on the set of records in data structure 232. A similar training process may be simultaneously conducted with respect to the functional neural network structure. In this case, however, the output of the neural network is a predicted receptor function (i.e., a biochemical function of the protein) that is compared to the actual function of the protein determined by controller 305 from protein function data in data structure 202 and encoded by receptor function index encoder 360. Conventional techniques are employed by decoders 350 and 370 to decode the predicted target domain index and predicted receptor function index, respectively.

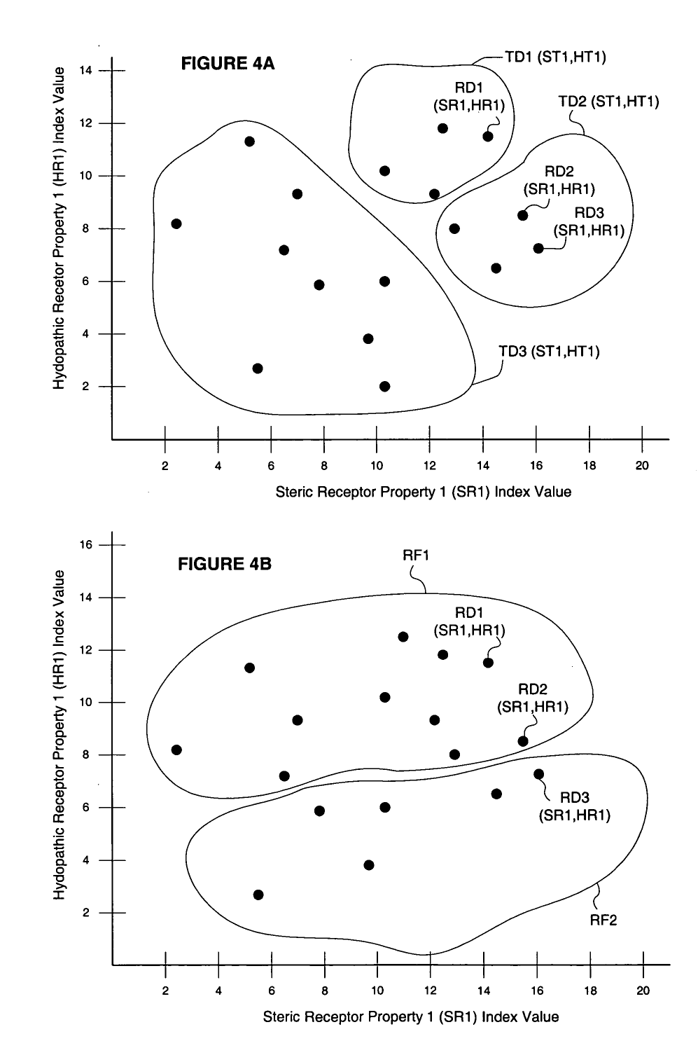

FIGS. 4A and 4B graphically represent the results of a training categorization or association by the domain and function neural networks, respectively, based on a simplified set of receptor domain index consisting of only two components. In these examples, it is illustratively assumed that those two components are a receptor hydropathic component (HR1) and a receptor steric component (SR1); thus N=2 and distances are computed in two-dimensional space. In particular, with respect to FIG. 4A, values of various receptor domains (such as RD1, RD2, and RD3) having components HR1 and SR1 are plotted in the two dimensional space. The domain neural network structure groups these receptor domains according to two-dimensional categories of target domains (TD1, TD2, and TD3) having components HT1 and ST1. Similarly, with respect to FIG. 4B, the function neural network structure groups the receptor domains according to receptor functions RF1 and RF2. As indicated, the same principles as described in these two-dimensional examples apply in any higher dimensional space.

In the query mode, a user 101 selects a gene or protein of interest. For example, the user may employ software typically provided with DNA arrays (e.g., synthesized oligonucleotide arrays or spotted cDNA arrays) to select a probe or probe set that has hybridized with a target and thus is indicative of gene expression or genotype. Similarly, the user may select a probe in a protein array. If the user selects a gene, then, as shown in FIG. 2, the DIP application manager provides the gene identifier (e.g., gi number or accession number) to any of a number of available gene to protein translators, e.g., National Center for Biotechnology Information (NCBI), tblastx server, http://www.ncbi.nlm.nih.gov/BLAST/; or Center for Biological Sequence Analysis, Prediction Servers, http://www.cbs.dtu.dk/services/. In the manner described above with respect to protein structure specifier 210, domain structure specifier 220, and domain property specifier 230 determine the properties of one or more domains in the query protein (a term hereafter understood to include, in some implementations, the protein corresponding to a query gene) and store these properties in records 232. With reference now to FIG. 3, mode controller 305 selects the properties of the query protein from records 232 and submits them to receptor domain index encoder 310. The encoded index is then provided to the trained domain neural network structure and the trained function neural network structure. These structures respond by providing at their output an encoded predicted target domain index 332 and encoded predicted receptor function index 334. For example, if it is assumed that the domain properties of a domain of the query protein are very similar to those represented by receptor domain 2 (RD2) of FIGS. 4A and 4B, then the domain neural network structure will predict that the target domain has the properties associated with target domain 2 (TD2) of FIG. 4A and the function neural network structure will predict that the query protein has the function associated with receptor function 1 (RF1) of FIG. 4B. After decoding, controller 305 compares the predicted target domain to domain-property records 232 to identify the one or more candidate proteins having domain properties most similar to those of the predicted target domain. The predicted target domain properties and the candidate proteins are reported to the user via display or other output devices 180 of user computer 100.

Various alternative implementations of DIP are possible. For example, although the process of populating domain-property records 232 may be carried out using conventional techniques and currently available stand-alone software programs or Internet-based applications, it may be found that, in some implementations, these programs may not characterize the hydropathic, steric, and electrostatic properties of a three-dimensional portion of a protein associated with a binding domain to a degree of accuracy desirable for reliable training of the domain neural network structure. In this event or as an alternative implementation, parallel calculation of domain properties using alternative techniques or applications may be employed and a combination or other statistical representation of alternative results may be selected. It is also possible that aspects of the neural network design may be supplemented, or replaced, in some implementations by other types of adaptive or learning approaches, such as Bayesian algorithms and structures (see, for example, D. Mount, Bioinformatics: Sequence and Genome Analysis (Cold Spring Harbor Laboratory Press, 2001), at 124-128; or P. Baldi, S. Brunak and S. Brunak, Bioinformatics (MIT Press, 2001).

As noted, user 101 may specify a query protein or a query gene based on experiments with microarrays. The expanding use of microarray technology is one of the forces driving the development of bioinformatics. In particular, microarrays and associated instrumentation and computer systems have been developed for rapid and large-scale collection of data about the expression of genes or expressed sequence tags (EST's) in tissue samples. The data may be used, among other things, to study genetic characteristics and to detect mutations relevant to genetic and other diseases or conditions. More specifically, the data gained through microarray experiments is valuable to researchers because, among other reasons, many disease states can potentially be characterized by differences in the expression levels of various genes, either through changes in the copy number of the genetic DNA or through changes in levels of transcription (e.g., through control of initiation, provision of RNA precursors, or RNA processing) of particular genes. Thus, for example, researchers use microarrays to answer questions such as: Which genes are expressed in cells of a malignant tumor but not expressed in either healthy tissue or tissue treated according to a particular regime? Which genes or EST's are expressed in particular organs but not in others? Which genes or EST's are expressed in particular species but not in others?

A microarray, or probe array, such as probe array 103 of FIG. 1 may provide information that user 101 may employ to select query genes and/or query proteins. This process may involve, in addition to the microarray, use of a scanner and software application for processing and interpreting the results of scanning the microarray. Following is a description of illustrative embodiments of these elements.

Various techniques and technologies may be used for synthesizing dense arrays of biological materials on or in a substrate or support. For example, Affymetrix® GeneChip® arrays are synthesized in accordance with techniques sometimes referred to as VLSIPS™ (Very Large Scale Immobilized Polymer Synthesis) technologies. Some aspects of VLSIPS™ and other microarray manufacturing technologies are described in U.S. Pat. Nos. 5,424,186; 5,143,854; 5,445,934; 5,744,305; 5,831,070; 5,837,832; 6,022,963; 6,083,697; 6,291,183; 6,309,831; and 6,310,189, all of which are hereby incorporated by reference in their entireties for all purposes. The probes of these arrays in some implementations consist of nucleic acids that are synthesized by methods including the steps of activating regions of a substrate and then contacting the substrate with a selected monomer solution. As used herein, nucleic acids may include any polymer or oligomer of nucleosides or nucleotides (polynucleotides or oligonucleotides) that include pyrimidine and/or purine bases, preferably cytosine, thymine, and uracil, and adenine and guanine, respectively. Nucleic acids may include any deoxyribonucleotide, ribonucleotide, and/or peptide nucleic acid component, and/or any chemical variants thereof such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states. Probes of other biological materials, such as peptides or polysaccharides as non-limiting examples, may also be formed. For more details regarding possible implementations, see U.S. Pat. No. 6,156,501, which is hereby incorporated by reference herein in its entirety for all purposes.

A system and method for efficiently synthesizing probe arrays using masks is described in U.S. patent application, Ser. No. 09/824,931, filed Apr. 3, 2001, that is hereby incorporated by reference herein in its entirety for all purposes. A system and method for a rapid and flexible microarray manufacturing and online ordering system is described in U.S. Provisional Patent Application, Serial No. 60/265,103, filed Jan. 29, 2001, that also is hereby incorporated herein by reference in its entirety for all purposes. Systems and methods for optical photolithography without masks are described in U.S. Pat. No. 6,271,957 and in U.S. patent application No. 09/683,374 filed Dec. 19, 2001, both of which are hereby incorporated by reference herein in their entireties for all purposes.

The probes of synthesized probe arrays typically are used in conjunction with biological target molecules of interest, such as cells, proteins, genes or EST's, other DNA sequences, or other biological elements. More specifically, the biological molecule of interest may be a ligand, receptor, peptide, nucleic acid (oligonucleotide or polynucleotide of RNA or DNA), or any other of the biological molecules listed in U.S. Pat. No. 5,445,934 (incorporated by reference above) at column 5, line 66 to column 7, line 51. For example, if transcripts of genes are the interest of an experiment, the target molecules would be the transcripts. Other examples include protein fragments, small molecules, etc. Target nucleic acid refers to a nucleic acid (often derived from a biological sample) of interest. Frequently, a target molecule is detected using one or more probes. As used herein, a probe is a molecule for detecting a target molecule. A probe may be any of the molecules in the same classes as the target referred to above. As non-limiting examples, a probe may refer to a nucleic acid, such as an oligonucleotide, capable of binding to a target nucleic acid of complementary sequence through one or more types of chemical bonds, usually through complementary base pairing, usually through hydrogen bond formation. As noted above, a probe may include natural (i.e. A, G, U, C, or T) or modified bases (7-deazaguanosine, inosine, etc.). In addition, the bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages. Other examples of probes include antibodies used to detect peptides or other molecules, any ligands for detecting its binding partners. When referring to targets or probes as nucleic acids, it should be understood that these are illustrative embodiments that are not to limit the invention in any way.

The samples or target molecules of interest (hereafter, simply targets) are processed so that, typically, they are spatially associated with certain probes in the probe array. For example, one or more tagged targets are distributed over the probe array. In accordance with some implementations, some targets hybridize with probes and remain at the probe locations, while non-hybridized targets are washed away. These hybridized targets, with their tags or labels, are thus spatially associated with the probes. The hybridized probe and target may sometimes be referred to as a probe-target pair. Detection of these pairs can serve a variety of purposes, such as to determine whether a target nucleic acid has a nucleotide sequence identical to or different from a specific reference sequence. See, for example, U.S. Pat. No. 5,837,832, referred to and incorporated above. Other uses include gene expression monitoring and evaluation (see, e.g., U.S. Pat. No. 5,800,992 to Fodor, et al.; U.S. Pat. No. 6,040,138 to Lockhart, et al.; and International App. No. PCT/US98/15151, published as WO99/05323, to Balaban, et al.), genotyping (U.S. Pat. No. 5,856,092 to Dale, et al.), or other detection of nucleic acids. The '992, '138, and '092 patents, and publication WO99/05323, are incorporated by reference herein in their entireties for all purposes.

Other techniques exist for depositing probes on a substrate or support. For example, “spotted arrays” are commercially fabricated, typically on microscope slides. These arrays consist of liquid spots containing biological material of potentially varying compositions and concentrations. For instance, a spot in the array may include a few strands of short oligonucleotides in a water solution, or it may include a high concentration of long strands of complex proteins. The Affymetrix® 417™ Arrayer and 427™ Arrayer are devices that deposit densely packed arrays of biological materials on microscope slides in accordance with these techniques. Aspects of these, and other, spot arrayers are described in U.S. Pat. Nos. 6,040,193 and 6,136,269; in U.S. patent application Ser. No. 09/683,298; and in PCT Application No. PCT/US99/00730 (International Publication Number WO 99/36760), all of which are hereby incorporated by reference in their entireties for all purposes. Other techniques for generating spotted arrays also exist. For example, U.S. Pat. No. 6,040,193 to Winkler, et al. is directed to processes for dispensing drops to generate spotted arrays. The '193 patent, and U.S. Pat. No. 5,885,837 to Winkler, also describe the use of micro-channels or micro-grooves on a substrate, or on a block placed on a substrate, to synthesize arrays of biological materials. These patents further describe separating reactive regions of a substrate from each other by inert regions and spotting on the reactive regions. The '193 and '837 patents are hereby incorporated by reference in their entireties. Another technique is based on ejecting jets of biological material to form a spotted array. Other implementations of the jetting technique may use devices such as syringes or piezo electric pumps to propel the biological material. It will be understood that the foregoing are non-limiting examples of techniques for synthesizing, depositing, or positioning biological material onto or within a substrate. For example, although a planar array surface is preferred in some implementations of the foregoing, a probe array may be fabricated on a surface of virtually any shape or even a multiplicity of surfaces. Arrays may comprise probes synthesized or deposited on beads, fibers such as fiber optics, glass or any other appropriate substrate, see U.S. Pat. Nos. 6,361,947, 5,770,358, 5,789,162, 5,708,153 and 5,800,992, all of which are hereby incorporated in their entireties for all purposes. Arrays may be packaged in such a manner as to allow for diagnostics or other manipulation of samples, reagents, detecting elements, or other materials or elements in an all inclusive device, see for example, U.S. Pat. Nos. 5,856,174 and 5,922,591 incorporated in their entireties by reference for all purposes. The words “diagnostic” and “diagnostics” are intended to have a broad meaning as used herein including detecting or determining a propensity for or susceptibility to a disease or condition; detecting or determining a response (whether beneficial or otherwise) to a proposed or actual treatment, therapy or regimen (including efficacious or adverse reactions to drugs); and/or classifying, sub-classifying, and/or quantifying states or other attributes of a disease or condition.

To ensure proper interpretation of the term “probe” as used herein, it is noted that contradictory conventions exist in the relevant literature. The word “probe” is used in some contexts to refer not to the biological material that is synthesized on a substrate or deposited on a slide, as described above, but to what has been referred to herein as the “target.” To avoid confusion, the term “probe” is used herein to refer to probes such as those synthesized according to the VLSIPS™ technology; the biological materials deposited so as to create spotted arrays; and materials synthesized, deposited, or positioned to form arrays according to other current or future technologies. Thus, microarrays formed in accordance with any of these technologies may be referred to generally and collectively hereafter for convenience as “probe arrays.” Moreover, the term “probe” is not limited to probes immobilized in array format. Rather, the functions and methods described herein may also be employed with respect to other parallel assay devices. For example, these functions and methods may be applied with respect to probe-set identifiers that identify probes immobilized on or in beads, optical fibers, or other substrates or media.

Probes typically are able to detect the expression of corresponding genes or EST's by detecting the presence or abundance of mRNA transcripts present in the target. This detection may, in turn, be accomplished in some implementations by detecting labeled cRNA that is derived from cDNA derived from the mRNA in the target. In general, a group of probes, sometimes referred to as a probe set, contains sub-sequences in unique regions of the transcripts and does not correspond to a full gene sequence. Further details regarding the design and use of probes and probe sets are provided in U.S. Pat. No. 6,188,783; in PCT Application Ser. No. PCT/US 01/02316, filed Jan. 24, 2001; and in U.S. patent applications Ser. No. 09/721,042, filed on Nov. 21, 2000, Ser. No. 09/718,295, filed on Nov. 21, 2000, Ser. No. 09/745,965, filed on Dec. 21, 2000, and Ser. No. 09/764,324, filed on Jan. 16, 2001, all of which patents and patent applications are hereby incorporated herein by reference in their entireties for all purposes.

Scanner 190 of FIG. 1 is an illustrative system that is suitable for, among other things, analyzing probe arrays that have been hybridized with labeled targets. Representative hybridized probe arrays 103 of FIG. 1 may include probe arrays of any type, as noted above. Labeled targets in hybridized probe arrays 103 may be detected using various commercial devices, referred to for convenience hereafter as “scanners.” Scanners image the targets by detecting fluorescent or other emissions from the labels, or by detecting transmitted, reflected, or scattered radiation. These processes are generally and collectively referred to hereafter for convenience simply as involving the detection of “emissions.” Various detection schemes are employed depending on the type of emissions and other factors. A typical scheme employs optical and other elements to provide excitation light and to selectively collect the emissions. Also generally included are various light-detector systems employing photodiodes, charge-coupled devices, photomultiplier tubes, or similar devices to register the collected emissions. For example, a scanning system for use with a fluorescent label is described in U.S. Pat. No. 5,143,854, incorporated by reference above. Other scanners or scanning systems are described in U.S. Pat. Nos. 5,578,832; 5,631,734; 5,834,758; 5,936,324; 5,981,956; 6,025,601; 6,141,096; 6,185,030; and 6,201,639; in PCT Application PCT/US99/ 06097 (published as WO99/47964); and in U.S. patent applications, Ser. Nos. 09/682,837 filed Oct. 23, 2001, Ser. No. 09/683,216 filed Dec. 3, 2001, and Ser. No. 09/683,217 filed Dec. 3, 2001, Ser. No. 09/683,219 filed Dec. 3, 2001, each of which is hereby incorporated by reference in its entirety for all purposes.

Scanner 190 provides data representing the intensities (and possibly other characteristics, such as color) of the detected emissions, as well as the locations on the substrate where the emissions were detected. The data typically are stored in a memory device, such as system memory 120 of user computer 100, in the form of a data file. One type of data file, sometimes referred to as an image data file, typically includes intensity and location information corresponding to elemental sub-areas of the scanned substrate. The term “elemental” in this context means that the intensities, and/or other characteristics, of the emissions from this area each are represented by a single value. When displayed as an image for viewing or processing, elemental picture elements, or pixels, often represent this information. Thus, for example, a pixel may have a single value representing the intensity of the elemental sub-area of the substrate from which the emissions were scanned. The pixel may also have another value representing another characteristic, such as color. For instance, a scanned elemental sub-area in which highintensity emissions were detected may be represented by a pixel having high luminance (hereafter, a “bright” pixel), and low-intensity emissions may be represented by a pixel of low luminance (a “dim” pixel). Alternatively, the chromatic value of a pixel may be made to represent the intensity, color, or other characteristic of the detected emissions. Thus, an area of high-intensity emission may be displayed as a red pixel and an area of low-intensity emission as a blue pixel. As another example, detected emissions of one wavelength at a particular sub-area of the substrate may be represented as a red pixel, and emissions of a second wavelength detected at another sub-area may be represented by an adjacent blue pixel. Many other display schemes are known. Two examples of image data are data files in the form *.dat or*.tif as generated respectively by Affymetrix® Microarray Suite based on images scanned from GeneChip® arrays, and by Affymetrix® Jaguar™ software based on images scanned from spotted arrays.

Generally, a human being may inspect a printed or displayed image constructed from the data in an image file and may identify those cells that are bright or dim, or are otherwise identified by a pixel characteristic (such as color). However, it frequently is desirable to provide this information in an automated, quantifiable, and repeatable way that is compatible with various image processing and/or analysis techniques. For example, the information may be provided for processing by a computer application that associates the locations where hybridized targets were detected with known locations where probes of known identities were synthesized or deposited. Other methods include tagging individual synthesis or support substrates (such as beads) using chemical, biological, electro-magnetic transducers or transmitters, and other identifiers. Information such as the nucleotide or monomer sequence of target DNA or RNA may then be deduced. Techniques for making these deductions are described, for example, in U.S. Pat. No. 5,733,729, which hereby is incorporated by reference in its entirety for all purposes, and in U.S. Pat. No. 5,837,832, noted and incorporated above.

A variety of computer software applications, represented in FIG. 1 by probe-array analysis applications 196, are commercially available for controlling scanners (and other instruments related to the hybridization process, such as hybridization chambers), and for acquiring and processing the image files provided by the scanners. Examples are the Jaguar™ application from Affymetrix, Inc., aspects of which are described in PCT Application PCT/US 01/26390 and in U.S. patent applications, Ser. Nos. 09/681,819, 09/682,071, 09/682,074, and 09/682,076, and the Microarray Suite application from Affymetrix, aspects of which are described in U.S. Provisional Patent Applications, Ser. Nos. 60/220,587, 60/220,645 and 60/312,906, all of which are hereby incorporated herein by reference in their entireties for all purposes. For example, image data may be operated upon to generate intermediate results such as so-called cell intensity files (*.cel) and chip files (*.chp), generated by Microarray Suite or spot files (*.spt) generated by Jaguar™ software. For convenience, the terms “file” or “data structure” may be used herein to refer to the organization of data, or the data itself generated or used by application 196 and other applications such as DIP application 199. However, it will be understood that any of a variety of alternative techniques known in the relevant art for storing, conveying, and/or manipulating data may be employed, and that the terms “file” and “data structure” therefore are to be interpreted broadly. In the illustrative case in which an image data file is derived from a GeneChip® probe array, and in which Microarray Suite generates a cell intensity file, the cell intensity file may contain, for each probe scanned by scanner 190, a single value representative of the intensities of pixels measured by scanner 190 for that probe. Thus, this value is a measure of the abundance of tagged cRNA's present in the target that hybridized to the corresponding probe. Many such cRNA's may be present in each probe, as a probe on a GeneChip® probe array may include, for example, millions of oligonucleotides designed to detect the cRNA's. The resulting data stored in the chip file may include degrees of hybridization, absolute and/or differential (over two or more experiments) expression, genotype comparisons, detection of polymorphisms and mutations, and other analytical results. In another example involving image data from a spotted probe array, the resulting spot file includes the intensities of labeled targets that hybridized to probes in the array. Further details regarding cell files, chip files, and spot files are provided in U.S. Provisional Patent Application Nos. 60/220,645, 60/220,587, and 60/226,999, incorporated by reference herein in their entireties for all purposes.

The processed image files produced by these applications often are further processed to extract additional data (e.g., microarray experiment data 198). In particular, data-mining software applications often are used for supplemental identification and analysis of biologically interesting patterns or degrees of hybridization of probe sets. An example of a software application of this type is the Affymetrix® Data Mining Tool, described in U.S. Provisional Patent Applications, Serial Nos. 60/274,986 and 60/312,256, both of which are hereby incorporated herein by reference in their entireties for all purposes. Software applications also are available for storing and managing the enormous amounts of data that often are generated by probe-array experiments and by the image processing and data-mining software noted above. An example of these data-management software applications is the Affymetrix® Laboratory Information Management System (LIMS), aspects of which are described in U.S. patent application No. 09/682,098 and in U.S. Provisional Patent Applications, Serial Nos. 60/220,587 and 60/220,645, all of which are hereby incorporated by reference herein in their entireties for all purposes. In addition, various proprietary databases accessed by database management software, such as the Affymetrix® EASI (Expression Analysis Sequence Information) database and database software, provide researchers with associations between probe sets and gene or EST identifiers.

For convenience of reference, these types of computer software applications (i.e., for acquiring and processing image files, data mining, data management, and various database and other applications related to probe-array analysis) are generally and collectively represented in FIG. 1 as probe-array analysis applications 196. As will be appreciated by those skilled in the relevant art, it is not necessary that application 196 (or DIP application 199) be stored on and/or executed from computer 100; rather, applications 196 or 199 may be stored on and/or executed from an applications server or other computer platform to which computer 100 is connected in a network. For example, it may be particularly advantageous for applications involving the manipulation of large databases, such as Affymetrix® LIMS or Affymetrix® Data Mining Tool (DMT), to be executed from a database server. Such networked arrangements may be implemented in accordance with known techniques using commercially available hardware and software, such as those available for implementing a local-area network or wide-area network.

Having described various embodiments and implementations, it should be apparent to those skilled in the relevant art that the foregoing is illustrative only and not limiting, having been presented by way of example only. Numerous other embodiments, and modifications thereof, are contemplated as falling within the scope of the present invention.

All patents, books, articles, and other publications referred to herein are hereby incorporated by reference in their entireties herein for all purposes.

What is claimed is:

1. A system for determining protein domain interactions, comprising:
an application manager constructed and arranged to receive one or more queries based, at least in part, on properties of a query domain of a query protein,
an adaptive learner constructed and arranged to adapt one or more parameters based, at least in part, on one or more properties of a plurality of training domains and to respond to the query based, at least in part, on the adapted parameters.

2. The system of claim 1, wherein:
the properties of the training domains, the properties of the query domains, or both, are encoded.

3. The system of claim 1, further comprising:
a domain property specifier constructed and arranged to specify one or more properties of each of the training domains and to specify one or more properties of the query domain; and
an encoder constructed and arranged to encode the properties of the training domains and the properties of the query domain.

4. The system of claim 1, wherein:
the adaptive learner includes any one or any combination of an artificial neural network, a Bayesian algorithm, or a statistical model or system including adaptive elements.

5. The system of claim 1, wherein:
the one or more properties of the training domains and the one or more properties of the query domain include any one or more of steric, hydropathic, or electrostatic properties.

6. The system of claim 1, wherein:
at least one of the one or more queries is determined, at least in part, based on a result of an experiment including a microarray.

7. The system of claim 1, wherein:
the query protein is determined, at least in part, based on a query gene.

8. The system of claim 7, wherein:
the query gene is determined, at least in part, based on a result of an experiment or test including a microarray.

9. The system of claim 7, wherein:
the experiment or test is a research or diagnostic experiment or test, or any combination thereof.

10. The system of claim 1, further comprising:
an adaptive function structure including an artificial neural network, Bayesian algorithm, a statistical model or system, or any combination thereof, constructed and arranged to predict a function of a protein based on the physical and/or chemical properties of one or more domains of the protein.

11. A method, comprising the acts of:
receiving one or more properties of each of a plurality of training domains;
receiving one or more queries based, at least in part, on one or more properties of a query domain of a query protein;
adapting one or more parameters based, at least in part, on the properties of the training domains; and
responding to the one or more queries based, at least in part, on the adapted parameters.

12. The method of claim 11, further comprising the act of:
predicting a function of a protein based on the physical and/or chemical properties of one or more domains of the protein.

13. The method of claim 11, wherein:
the one or more properties of the training domains and the one or more properties of the query domain include any one or more of steric, hydropathic, or electrostatic properties.

14. The method of claim 11, wherein:
one or more of the acts of specifying, encoding, adapting, or responding is computer implemented.

15. The method of claim 11, further comprising the act of:
receiving one or more functions of proteins corresponding to the plurality of training domains;
and wherein the act of adapting one or more parameters includes adapting based, at least in part, on the functions.

16. A system, comprising:
means for specifying one or more properties of each of a plurality of training domains and specifying one or more properties of a query domain of a query protein;
means for encoding the properties of the training domains and the properties of the query domain;
means for adapting one or more parameters based on the encoded properties of the training domains and responding to the encoded properties of the query domain based, at least in part, on the adapted parameters.

17. The system of claim 16, further comprising:
means for predicting a function of a protein based on the physical and/or chemical properties of one or more domains of the protein.

18. The system of claim 16, wherein:
the adapting means include any one or any combination of an artificial neural network, a Bayesian algorithm, or a statistical model or system including adaptive elements.

19. The system of claim 16, wherein:
the query protein is determined, at least in part, based on a result of an experiment or test including a microarray.

20. The system of claim 19, wherein:
the experiment or test is a research or diagnostic experiment or test, or any combination thereof.
